(19) United States
(12) Patent Application Publication
(10) Pub. No.: US 2006/0108273 A1
(43) Pub. Date: May 25, 2006

(54) Ballasted flocculation process and system incorporating an electro-coagulation reactor for treating water or wastewater

(76) Inventors: Joyce Standley Perri, Beaver Falls, PA (US); William Martin Hertel III, Annapolis, MD (US)

Correspondence Address: COATS & BENNETT, PLLC, P O BOX 5, RALEIGH, NC, 27602, US

(21) Appl. No.: 11/050,918

(22) Filed: Feb. 4, 2005

Related U.S. Application Data
(60) Provisional application No. 60/542,734, filed on Feb. 6, 2004.

(51) Int. Cl. B01D 24/00

(52) U.S. Cl. 210/275

(57) ABSTRACT

A method and apparatus for treating wastewater is described herein. The present invention combines an electro-coagulation process with a ballasted flocculation process to treat contaminated water or wastewater. More particularly, an electro-coagulation treatment process produces gas, precipitates dissolved contaminants, and/or aggregates suspended solids, while the ballasted flocculation treatment process produces clarified effluent.

This application claims priority from provisional application Ser. No. 60/542,734, filed 6 Feb. 2004 with the United States Patent and Trademark Office.

### BACKGROUND OF THE INVENTION

The present invention relates generally to water or wastewater treatment, and more particularly to a combination electro-coagulation and ballasted flocculation treatment process.

Effective water and wastewater treatment is an important part of industrial and community operations. Over time, manufacturers have developed different treatment processes. Currently, many treatment processes combine a precipitation process with a clarification process. For example, an exemplary treatment process may use chemical precipitation in combination with ballasted flocculation to produce clarified effluent from untreated water or wastewater. However, many of the chemicals used in the chemical precipitation process are expensive. Further, because many of the chemicals are corrosive, and therefore hazardous, handling the chemicals requires special procedures to meet environmental guidelines, which adds to the overall cost of the treatment operations.

To eliminate the use of the hazardous and costly chemicals, other exemplary treatment processes may combine an electro-coagulation process, that precipitates dissolved contaminants, with a filtration process to produce the clarified effluent. However, conventional filtration systems suitable for small scale or mobile operations typically do not produce clarified effluent that meets environmental requirements, even when combined with an electro-coagulation system. Larger filtration systems capable of satisfying the environmental requirements are typically too large for small scale or mobile operations.

### SUMMARY OF THE INVENTION

The present invention is a method and apparatus for water or wastewater treatment that eliminates the use of hazardous chemicals without sacrificing size, cost, or treatment quality. According to one exemplary embodiment, the present invention combines an electro-coagulation process with a ballasted flocculation process to treat contaminated water or wastewater.

In one particular embodiment, an electro-coagulation treatment process produces gas, precipitates dissolved contaminants, and/or aggregates suspended solids, while the ballasted flocculation treatment process produces clarified effluent. Further, some exemplary embodiments of the present invention may also include a de-gas system that removes at least a portion of the gas generated during the electro-coagulation process to facilitate the clarification process.

### BRIEF DESCRIPTION OF THE DRAWINGS

FIG. 1 illustrates one exemplary water or wastewater treatment system according to the present invention.

FIG. 2 illustrates one exemplary electro-coagulation system.

FIG. 3 illustrates one exemplary de-gas system.

### DETAILED DESCRIPTION OF THE INVENTION

The present invention entails a combination electro-coagulation and ballasted flocculation process and system for treating water or wastewater. The water or wastewater treated by the treatment system described herein may comprise any known untreated water or wastewater, and typically contains dissolved, emulsified, and/or suspended contaminants, such as fine particles, colloids, oils, dissolved metals, etc.

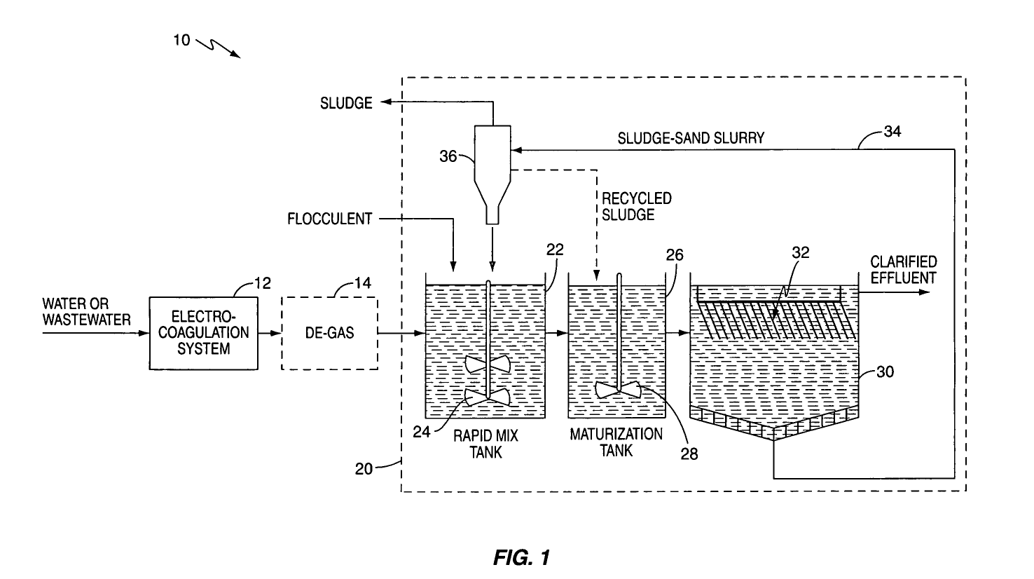

FIG. 1 illustrates an exemplary water or wastewater treatment system 10 according to the present invention. Treatment system 10 includes an electro-coagulation system 12, a ballasted flocculation system 20, and optionally, a de-gas system 14. Electro-coagulation system 12 functions as a precipitation system that precipitates dissolved contaminants and aggregates suspended solid contaminants in the untreated water or wastewater. The water or wastewater then passes through the ballasted flocculation system 20 for further treatment to produce the clarified effluent. When necessary, treatment system 10 also includes de-gas system 14 to remove at least some of the gases generated during the electro-coagulation process. The following discusses each of these elements, as they apply to the present invention, in further detail.

Electro-coagulation system 12 typically comprises two or more spaced apart electrode plates physically disposed parallel to one another so as to define an electro-coagulation reactor cell for the water or wastewater to pass between. When untreated water or wastewater is directed into or through the electro-coagulation reactor cell(s), an electrical current supplied to the electrode plates provides an electromotive force that produces chemical reactions in the untreated water or wastewater. These chemical reactions result in the destabilization of suspended, emulsified, or dissolved contaminants, as discussed further below. This destabilization results in the precipitation of dissolved contaminants, the aggregation of suspended solids, and/or the generation of various gasses, i.e., hydrogen, oxygen, ammonia, and/or chlorine gases.

FIG. 2 illustrates a functional block diagram of one basic exemplary electro-coagulation system 12. As shown in FIG. 2, electro-coagulation system 12 generally comprises at least one reactor cell 50 that includes at least two spaced apart parallel electrode plates 52, where one electrode plate 52 electrically connects to a positive node of a power supply 54 and the other electrode plate 52 electrically connects to a negative node of power supply 54. The electrode plates 52 may be constructed of various conductive materials that donate ions under the influence of supplied electrical current. For example, electrode plates 52 may be constructed of iron, aluminum, or a combination of both. In some embodiments, electrode plates 52 may be constructed of steel, copper, titanium, carbon, platinum, impregnated plastics, ceramics, and/or other materials that donate ions under the influence of supplied electrical current.

Power supply 54 electrically charges electrode plates 52 to trigger the ion donation process described further below. Typically, power supply 54 charges the electrode plates 54 with a direct current (DC). As such, power supply 54 may comprise any DC source, such as a battery. Alternatively, power supply 54 may also comprise and alternating current (AC) source and a rectifier (not shown). As well understood, the rectifier rectifies the alternating current to generate the desired DC electrical current, and directs the resulting DC electrical current to the electrode plates 52. While not specifically shown, those skilled in the art will appreciate that the polarity of the DC voltage generated by the rectifier may be reversed periodically, for example, every 20 to 30 minutes, to provide for uniform wear of the electrode plates 52. In addition, treatment system 10 may include an apparatus and/or method for cleaning/flushing the electrode plates 52 while in service to prevent the build-up of contaminants on the electrode plates 52.

In any event, when supplied with current, the anode or positive electrode plate 52 sacrifices ions, i.e., aluminum ions, iron ions, etc. These ions move into the untreated water or wastewater disposed between electrode plates 52. As such, the water or wastewater is exposed to a variety of chemical or physical processes that neutralize or disrupt the stable surface charges sustaining the dispersed condition of the contaminants. These chemical and physical processes may include, but are not limited to, ionization, electrolysis, hydrolysis, free radical formation, and/or magnetic effects. As a result, positively and negatively charged contaminants form and attract each other, causing the contaminants to precipitate into particles large enough to be removed by filtration, centrifugal separation, or other common wastewater filtration processes.

While FIG. 2 only shows an electro-coagulation system 12 having a single reactor cell 50, those skilled in the art will appreciate that electro-coagulation system 12 may comprise a single electro-coagulation reactor cell 50 or a series of such reactor cells 50. It will further be appreciated that the amount and composition of the particular contaminants present in the untreated water or wastewater may determine the size of the electro-coagulation system 12 and the size and number of the reactor cells 50 and/or electrode plates 52. Typically, as the concentration of waste in the untreated water or wastewater increases, the number and/or size of the electro-coagulation reactor cells 50 also increases to increase the efficiency of the electro-coagulation system 12.

Further, the required amount of current and voltage supplied by power supply 54 depends on the volume of wastewater being treated, the type and concentration of contaminants, and of course, the physical size and number of reactor cell(s) 50 and/or electrode plates 52. Typically, for a single 25-gallon/minute system, supplying 150 amperes at 25 volts sufficiently precipitates and aggregates contaminants in the untreated water or wastewater passing through the electro-coagulation system 12.

Once pre-treated in the electro-coagulation system 12, the water or wastewater flows into the ballasted flocculation system 20, which may comprise a rapid mix tank 22, maturization tank 26, settling tank 30, and sludge-separation system 36, as shown in FIG. 1. The water or wastewater flows into a first downstream tank, referred to herein as a rapid mix chamber or tank 22 having a mixer 24 therein. Here, a flocculent, such as a polymer, is injected into the water or wastewater along with an insoluble granular material, such as microsand. When mixed with mixer 24, the polymer and insoluble granular material initiate floc formation. That is, the suspended solids in the water or wastewater aggregate, collect together, and build up around the particles of insoluble granular material to form floc.

From the first tank 22, the mixture, which contains the flocculent, insoluble granular material, and floc, flows into maturization tank 26, which includes a mixer 28 that gently mixes the mixture. Mixer 28 provides ideal conditions for the formation of polymer bridges between the insoluble granular material and the destabilized suspended solids and/or floc. As a result, maturization tank 26 produces water or wastewater containing ballasted flocs.

From the maturization tank 26, the water or wastewater with the formed ballasted flocs enters the downstream settling or sedimentation tank 30. Here the ballasted flocs settle rapidly. As the ballasted flocs settle to the bottom of settling tank 30, a sand-sludge slurry 34 collects at the bottom of tank 30. The sand-sludge slurry 34 is collected and pumped to a separation system 36, such as hydro-cyclone, for separation. Hydro-cyclone 36 separates the insoluble granular material from the sludge according to means known in the art. After separation, the insoluble granular material is concentrated and discharged from hydro-cyclone 36 and re-used in the ballasted flocculation process, as shown in FIG. 1. The lighter density sludge is discharged from the top of hydro-cyclone 36 and sent to a sludge thickening process or other conventional sludge treatment process. Optionally, some treatment systems may recycle some of the sludge back to the beginning of the treatment process or to the maturization tank 26, as shown by the dashed line in FIG. 1, to enhance the particle size of the suspended solids and the size of the floc formed in the maturization tank 26.

Settling the sludge and sand produces clarified effluent in settling tank 30. For the case of water, the clarified effluent exits the wastewater treatment system 10 and is filtered, disinfected, and distributed as drinking water. Alternatively, for the case of wastewater, the clarified effluent flows upward through inclined separator plates 32 or tube settlers in some cases, and exits treatment system 10 through a collection of troughs or weirs for further treatment and discharge. While FIG. 1 illustrates a settling tank 30 having separator plates 32, it will be appreciated by those skilled in the art that some settling tanks 30 may not require such structures, and that other means for separating the clarified effluent from the ballasted flocs and sand apply equally well to the present invention.

As shown in FIG. 1, treatment system 10 may also include an optional de-gas system 14. During the electro-coagulation process, various gases may form, as discussed above, and become entrained in the suspended solids. As a result, some or all of the suspended solids become buoyant. De-gas system 14 may be used to release or otherwise remove at least some of these gases to prevent the gases from interfering with the subsequent clarification process, i.e., the ballasted flocculation process discussed above.

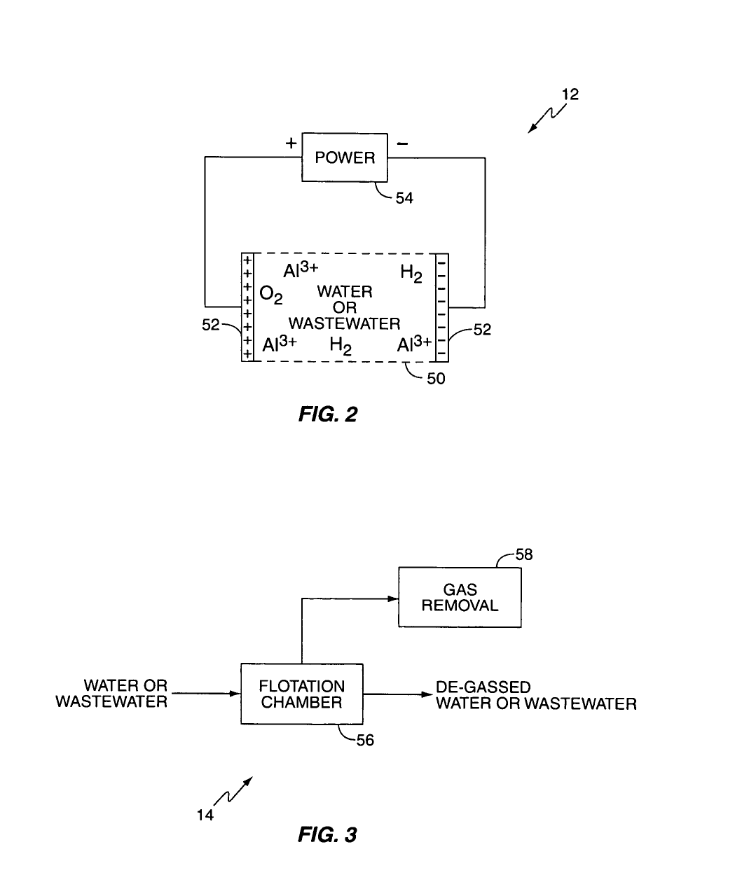

De-gas system 14 may implement any known de-gas or de-aeration processes, such as a spray or a reactive agent process for suppressing foam development caused by the gas(es). Alternatively, de-gas system 14 may comprise a flotation chamber 56 and a gas removal device 58, as shown in FIG. 3. Flotation chamber 56 holds the water or wastewater, allowing the buoyant suspended solids to float to the top. Gas removal device 58 then removes at least part of the floating suspended solids and entrained gases by any known means. For example, gas removal device 58 may comprise a skimmer configured to skim the floating solids and entrained gases from the top of the liquid in flotation chamber 56. Alternatively, gas removal device 58 may comprise a suction device that uses suction to remove at least part of the floating solids and entrained gas and/or may comprise a spray or reactive agent injection device to suppress foam development as a means for removing entrained gases. Those skilled in the art will also appreciate that gas removal device 58 may also comprise a device that allows the floating solids and entrained gases to flow over an overflow weir into a storage tank.

In summary, the present invention describes a combination electro-coagulation and ballasted flocculation water or wastewater treatment process and system. Electro-coagulation system replaces the chemical precipitation systems conventionally used in combination with the ballasted flocculation systems. As such, the present invention avoids the hazardous material requirements and costs associated with chemical precipitants. Further, because the ballasted flocculation system is a relatively small clarification system, as compared to the large filtration systems currently required to meet environmental standards, the present invention provides a compact system implementable as part of a mobile treatment system that is also capable of producing clarified effluent that meets environmental standards.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

The disclosures found in the following United States patents are expressly incorporated herein by reference: U.S. Pat. No. 5,730,864; U.S. Pat. No. 6,010,631; U.S. Pat. No. 4,827,543; U.S. Pat. No. 5,840,195; U.S. Pat. No. 5,928,493; U.S. Pat. No. 6,214,182; U.S. Pat. No. 6,294,061; and U.S. Patent Application Serial No. 2002/0088758.

What is claimed is:

1. A method of treating water or wastewater having at least one of suspended, emulsified, or dissolved contaminants, the method comprising:
treating the water or wastewater with an electro-coagulation treatment process, which results in at least one of the formulation of a gas, the precipitation of dissolved contaminants into suspended solids, and the aggregation of suspended solids;
removing at least a portion of the gas from the water or wastewater; and
treating the water or wastewater with a ballasted flocculation process to generate a clarified effluent.

2. The method of claim 1 wherein treating the water or wastewater with an electro-coagulation treatment process comprises passing the water or wastewater between at least two electrically charged electrode plates and releasing ions into the water or wastewater to initiate at least one of the precipitation of dissolved contaminants, the aggregation of suspended solids, and the formation of a gas.

3. The method of claim 2 wherein the electrode plates comprise at least one of aluminum, iron, titanium, copper, carbon, platinum, plastics impregnated with an ion donating material, and ceramics impregnated with an ion donating material.

4. The method of claim 1 wherein treating the water or wastewater with a ballasted flocculation process comprises:
mixing insoluble granular material with the water or wastewater to form a mixture;
subjecting the mixture to mixing and maintaining the insoluble granular material in suspension to form floc by aggregating the suspended solids around the granular material;
transferring the mixture to a separation tank; and
settling a sand-sludge slurry comprising the floc and residual insoluble granular material in the separation tank to separate the clarified effluent from the mixture.

5. The method of claim 4 further comprising:
transferring the settled sand-sludge slurry from the sedimentation tank;
processing the sand-sludge slurry by separating the sludge from the insoluble granular material to generate recycled granular material; and
using the recycled granular material in the ballasted flocculation process.

6. The method of claim 1 wherein removing at least a portion of the gas from the water or wastewater comprises:
directing the water or wastewater into at least one flotation chamber;
floating suspended solids made buoyant by the gas; and
removing at least a portion of the gas and buoyant suspended solids from the flotation chamber.

7. The method of claim 6 wherein removing at least a portion of the gas and suspended solids from the flotation chamber comprises at least one of skimming and suctioning the gas and suspended solids from the flotation chamber.

8. The method of claim 6 wherein removing at least a portion of the gas and suspended solids comprises spraying the water or wastewater in the flotation chamber or injecting a reactive agent into the flotation chamber to suppress foam generation to remove at least a portion of the gas.

9. The method of claim 1 wherein removing at least a portion of the gas from the water or wastewater comprises directing the water or wastewater through a de-gas apparatus.

10. The method of claim 1 wherein removing at least a portion of the gas from the water or wastewater comprises spraying the water or wastewater or injecting a reactive agent into the water or wastewater to suppress foam generation.

11. The method of claim 1 wherein the gas comprises at least one of hydrogen, oxygen, ammonia, and chlorine gas.

12. A system for treating water or wastewater having suspended, emulsified, or dissolved contaminants, the system comprising:
an electro-coagulation system configured to treat the water or wastewater with an electro-coagulation process, which results in at least one of the formulation of a gas, the precipitation of dissolved contaminants into suspended solids, and the aggregation of suspended solids; and
a ballasted flocculation system communicatively connected to the electro-coagulation system for treating the water or wastewater after the water or wastewater has been subjected to treatment by the electro-coagulation system.

13. The system of claim 12 further comprising a de-gas apparatus configured to remove at least a portion of the gas from the water or wastewater.

14. The system of claim 13 wherein the de-gas apparatus is configured to de-aerate the water or wastewater.

15. The system of claim 13 wherein the de-gas apparatus comprises at least one of a sprayer or a reactive agent injection device that suppresses foam generation in the water or wastewater.

16. The system of claim 13 wherein the de-gas apparatus comprises:
at least one flotation chamber configured to allow suspended solids made buoyant by the gas to float in the water or wastewater; and
a gas removal device configured to remove at least a portion of the gas and buoyant suspended solids from the flotation chamber.

17. The system of claim 16 wherein the gas removal device comprises at least one of a skimmer and a suction device.

18. The system of claim 16 wherein the gas removal device comprises at least one of a sprayer and a reactive agent injection device that suppresses foam generation in the water or wastewater.

19. The system of claim 12 wherein the electro-coagulation system comprises:
at least two spaced apart electrode plates generally disposed parallel to one another; and
an electrical source to electrically charge the electrode plates, causing the release of ions into the water or wastewater disposed between the electrically charged plates to initiate at least one of the precipitation of dissolved contaminants, the aggregation of suspended solids, and the formation of a gas.

20. The system of claim 19 wherein the electrode plates comprise plates made of a material that donates ions under the influence of supplied electrical current.

21. The system of claim 19 wherein the electrode plates comprise plates made of at least one of aluminum, iron, titanium, carbon, platinum, plastics impregnated with an ion donating material, and ceramics impregnated with an ion donating material.

22. The system of claim 12 wherein the ballasted flocculation system comprises:
a mix tank to combine insoluble granular material with the water or wastewater to form a mixture;
a maturization tank configured to subject the mixture to mixing to maintain the insoluble granular material in suspension and to aggregate suspended solids around the insoluble granular material to form floc; and
a sedimentation tank to separate the clarified effluent from the mixture by settling a sand-sludge slurry comprising the floc and residual insoluble granular material.

23. The system of claim 22 wherein the sedimentation tank includes separator plates, and wherein the clarified effluent flows upward through the separator plates to separate the clarified effluent from the floc.

24. The system of claim 22 wherein the ballasted flocculation system further comprises a sludge separation system configured to recycle the insoluble granular material by processing the sand-sludge slurry to separate the sludge from the insoluble granular material.

25. The system of claim 24 wherein the sludge separation system comprises a hydrocyclone.

26. A method of treating water or wastewater, the method comprising:
treating the water or wastewater with an electro-coagulation treatment process, which results in at least one of the formulation of a gas, the precipitation of dissolved contaminants into suspended solids, and the aggregation of suspended solids; and
after treating the water or wastewater with the electro-coagulation treatment process, subjecting the water or wastewater to further treatment with a ballasted flocculation process to generate a clarified effluent.

27. The method of claim 26 including producing at least one gas as a result of the electro-coagulation treatment process, and removing at least a portion of the gas prior to the water or wastewater being subjected to the ballasted flocculation process.

28. The method of claim 26 wherein treating the water or wastewater with the ballasted flocculation process includes adding insoluble granular material to the water or wastewater and aggregating suspended solids within the water or wastewater around the granular material to form flocs, and transferring the water or wastewater with the floc to a sedimentation tank and settling the floc therein and producing a clarified effluent.
